(19) United States
(12) Patent Application Publication
(10) Pub. No.: US 2011/0289138 A1
(43) Pub. Date: Nov. 24, 2011

(54) METHOD, MACHINE AND COMPUTER PROGRAM PRODUCT FOR SHARING AN APPLICATION SESSION ACROSS A PLURALITY OF DOMAIN NAMES

(76) Inventor: Bhavin TURAKHIA, Mumbai (IN)

(21) Appl. No.: 12/856,832

(22) Filed: Aug. 16, 2010

(30) Foreign Application Priority Data
May 20, 2010 (IN) 1585/MUM/2010

(51) Int. Cl. G06F 15/16

(52) U.S. Cl. 709/203; 709/228

(57) ABSTRACT

The present invention relates to method, machine and computer program product for sharing an application session across a plurality of domain names hosting an application without changing a URL in a user's browser. A first HTTP request is received for a first domain name from a client. When the first HTTP request comprises a first session identifier, a first response is sent to the client. The first response includes a first HTML page comprising a frame tag for triggering a second HTTP request to a central domain name. When the second HTTP request comprises a second session identifier, a second response is sent to the client. The second response comprises a second HTML page, which is a resource hosted on the first domain name. A third HTTP request is then triggered from the client for sending a third session identifier to the first domain name. Upon verifying that the third session identifier represents the same application session as the second session identifier, the third session identifier is set on the first domain name for the client, resulting in aggregation of the application session.

### FIELD OF THE INVENTION

The present invention relates generally to session management and, more specifically, to a method and machine for sharing an application session across a plurality of domain names, without changing a URL in a browser of a client.

### BACKGROUND OF THE INVENTION

Organizations, today, are constantly innovating and introducing newer applications on the Internet. For instance, Facebook offers their users a social network, a photo management service, a video publishing service etc. Similarly Google provides Gmail, Youtube, Notebook, Google Docs etc. All these products are accessible to a user through a single username and password. These applications maybe hosted on the same Uniform Resource Locator (URL) or domain name, such as facebook.com, or on different URLs or domain names such as youtube.com and gmail.com etc.

When these applications are hosted on the same URL e.g. facebook.com, there is no need for a single-sign on process. For instance, if Facebook were to offer various applications such as photos, social network, profile etc all hosted at URLs of the type facebook.com/photos and facebook.com/profile etc., then requests for any of these applications are sent to facebook.com. Therefore, any identifier, such as a cookie, set on facebook.com would be available to any of these applications. In this case, when a user logs in once, he can browse all applications within Facebook since the identifier created on the users machine will be sent out to any application whose URL contains “facebook.com”. Those skilled in the art will know that the HTTP Request For Comments (RFC) Standard permits setting an identifier on any level of a domain name except for the Top Level Domain (TLD).

Thus, if an organization owns games.TLD and jobs.TLD, then a user visiting games.TLD would receive a cookie set at games.TLD. Since a cookie cannot be set at the TLD level, jobs.TLD and games.TLD cannot obtain the same cookie. Therefore if a user is logged into one of the sites, the other site cannot identify that user.

While the surge in the number of applications provided by an organization is good for the users and the Internet as a whole, it is imperative that when a user browses across these applications or URLs, user experience is not compromised.

There are many Single sign-on techniques available today to provide a seamless browsing experience to a user. One such method includes, using a central URL on which the users' identifier is set upon login or visit. Subsequently, each independent Second Level Domain (SLD) needs to redirect the user to the central URL which detects if a session for the user exists and, if it does, it would redirect the user back to the original SLD along with a parameter that the original SLD can verify. This however results in the redirection being visible to the user and the URL in the browser changing during this redirection process, in turn affecting user experience.

Additionally, single sign-on methods are usually implemented on different applications hosted on two or more different domain names, wherein sharing of the same authentication information for a user is required.

There can, however, be Service Providers who host a same application on multiple domain names. For instance, a Service Provider of a Social Network may wish to host profiles of its users on different domain names. In such cases, it is desirable to implement single sign-on for a user, without having to redirect to a central URL, since that leads to poor user experience.

Hence, there is a need for a method and a machine that facilitates sharing of an application session across a plurality of domain names without changing the URL in a user's browser.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a flow diagram of a method for sharing an application session across a plurality of domain names in accordance with an embodiment of the present invention.

FIG. 2 illustrates a call flow diagram representing sharing of an application session across a plurality of domain names in accordance with an embodiment of the present invention.

FIG. 3 illustrates a block diagram of a machine for sharing an application session across a plurality of domain names in accordance with an embodiment of the present invention.

### DETAILED DESCRIPTION OF THE INVENTION

Before describing in detail embodiments that are in accordance with the invention, it should be observed that the embodiments reside primarily in combinations of method steps and machine components related to sharing an application session across a plurality of domain names. Accordingly, the machine components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,”, ‘including”, “containing” or any other variation thereof, are intended to cover a non-exclusive inclusion, such that a process, method, article, or machine that comprises a list of elements does not include only those elements but may include other elements not expressly listed or inherent to such process, method, article, or machine. An element proceeded by “comprises . . . a” does not, without more constraints, preclude the existence of additional identical elements in the process, method, article, or machine that comprises the element.

It will be appreciated that embodiments of the invention described herein may be comprised of one or more conventional processors and unique stored program instructions that control the one or more processors to implement, in conjunction with certain non-processor circuits, some, most, or all of the functions for sharing an application session across a plurality of domain names described herein. The non-processor circuits may include, but are not limited to, a radio receiver, a radio transmitter, signal drivers, clock circuits, power source circuits, and user input devices. As such, these functions may be interpreted as steps of a method for sharing an application session across a plurality of domain names. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Further, the term ‘computer-readable medium’ as used herein encompasses many forms including such common forms as, for example, but not limited to, a hard disk, an EPROM, a CD-ROM, a carrier wave, electrical, electromagnetic or optical signals, or any other medium from which a computer or any computing device can read.

The present invention relates generally to session management, wherein an application session is shared amongst multiple domain names. Thus, for a user, the experience of browsing from one domain name to another hosting a same application is extremely seamless. The application can be any application that requires user session management on the internet, for example, but not limited to, a social networking application, a photo management application, a video publishing application, an email application, a messaging application etc.

In a scenario, a social network may use different domain names for different user profiles. A user, Jack, can have his profile under the domain name Jack.TLD and another user, Jill, can have her profile under the domain name Jill.TLD. Here the TLD can be any Top Level Domain (TLD) such as com, net, etc. In fact, the TLDs in the two domain names, Jack.TLD and Jill.TLD, may be different, and all such embodiments are within the scope of the present invention.

Various embodiments of the present invention enable Jack, who is logged into the social network on Jack.TLD to access the domain name Jill.TLD without having to login to the social network again and without the URL in his browser changing.

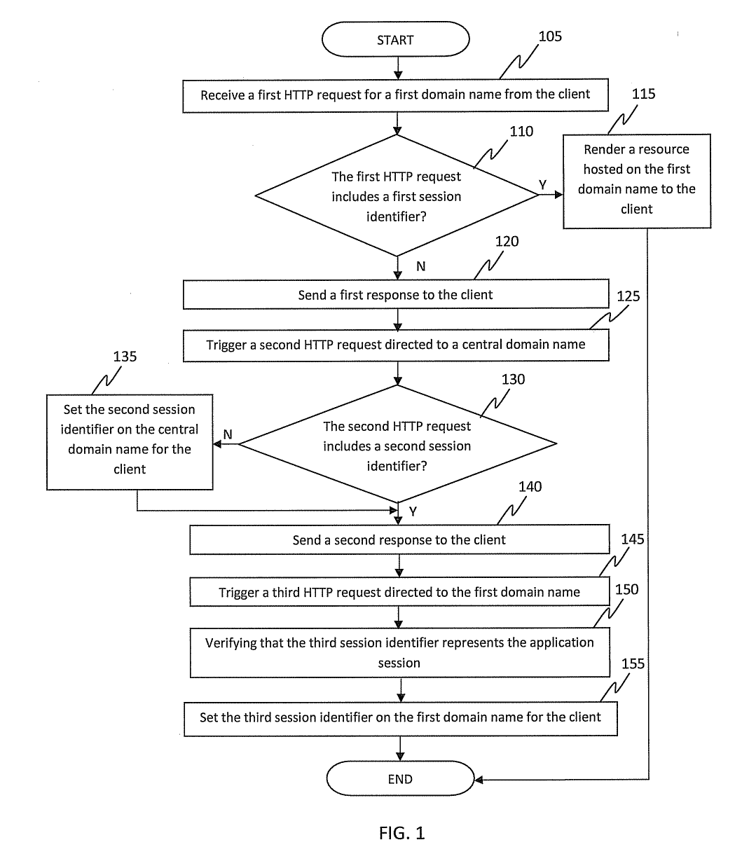

Referring now to the figures and in particular to FIG. 1, a flow diagram of a method for sharing an application session across a plurality of domain names is shown in accordance with an embodiment of the present invention. A Service Provider may render a same application on a plurality of domain names. For instance, a social network may host a user's profile on a first domain name and another user's profile on a second domain name. The method of FIG. 1 enables a user to browse from a first domain name to a second domain name seamlessly, without having to login again and without the URL changing in a browser window of the user.

At step 105, a first HTTP request is received from a client for a first domain name. The client can be one or more of, but not limited to, a user, a browser, a user's desktop etc. At step 110, it is checked if the first HTTP request includes a first session identifier set for the client on the first domain name. Those skilled in the art will appreciate that a session identifier can be a cookie set on the user's browser. Thus, if a live session exists for the client on the first domain name, the first session identifier, or a cookie, is found to be present on the client, or user's browser.

If the first HTTP request includes a first session identifier, it implies that the user has an active session on the first domain name and a resource hosted on the first domain name is rendered to the client at step 115.

If the first session identifier is absent in the first HTTP request, it implies that the user has no live session on the first domain name. This can happen when, for example, the user is not logged into the application.

When the first session identifier is absent in the first HTTP request, a first response is sent to the client at step 120. The first response comprises at least a first HTML page. The first HTML page may include a frame tag that triggers a second HTTP request to a central domain name belonging to the plurality of domain names at step 125. The first domain name may belong to a first TLD and the central domain name may belong to a second TLD, where the first TLD and the second TLD are either same or different, and all such variations are within the scope of the present invention.

The frame tag that triggers the second HTTP request to the central domain name can be of the form:

<frameset rows=“100%,0%”>

<frame id=“internalUrlFrame” src=“central domain name”
noresize>

</frameset>

Those skilled in the art will realize that the src=“central domain name” will cause the second HTTP request to be sent to the central domain name. Further, a <frameset> tag ensures that the second HTTP request is sent to the central domain name transparently without changing the domain name in the user's browser address bar to the central domain name. Thus, for the user, the second HTTP request to the central domain name is invisible.

At step 130, it is determined if the second HTTP request includes a second session identifier for the central domain name representing the application session. If the user is visiting the central domain name for the first time, or does not have an active application session on the central domain name, the second session identifier is absent in the second HTTP request.

If the second session identifier is absent in the second HTTP request, the application session is created for the client and the second session identifier is set on the central domain name for the client at step 135. In an embodiment of the invention, for creating the application session, a login page is rendered to the client. The user can then either enter his credentials, such as username and password, or create a new account if he is a new user. Once the credentials are validated, the client is logged into the application and the application session is created for the client.

The login page can be rendered in a frame within the browser window of the user. This ensures that the URL in the browser address bar of the user does not change to the central domain name and is retained as the first domain name.

In an embodiment of the present invention, the second session identifier is set for the client on a plurality of sub-domains under the central domain name. For instance, if the central domain name is home.TLD, the second session identifier can be set on home.TLD, jack.home.TLD, Jill.home.TLD etc.

Once the second session identifier is set on the client for the central domain name or it is determined, at step 130, that the second HTTP request includes the second session identifier, a second response is sent to the client at step 140. The second response includes a second HTML page. The second HTML page can be the resource hosted on the first domain name as requested by the client in the first HTTP request at step 105. For instance, the resource can be the user's profile hosted on the first domain name.

For example, if the first domain name is Jack.TLD and the central domain name is home.TLD, then jack.home.TLD is sent as the second response to the client at step 140. This can be done using the following HTML command:

<frameset rows=“100%,0%”>

<frame id=“mainFrame” src=“http://jack.home.TLD”>

</frameset>

Those skilled in the art will appreciate that jack.home.TLD can point to the same resource as Jack.TLD. Further, one or more links rendered in the “mainFrame” can all point to the first domain name, jack.TLD, and not to sub-domains within the central domain name, such as photos.jack.home.TLD, since jack.home.TLD points to the same resource as jack.TLD. This can be done by setting the ‘target’ attribute of the one or more links within the “mainFrame” to “_parent”. This ensures that the URL in the user's browser is consistent with the resource being rendered. The target can be set using the following HTML command:

<a href=“http://jack.TLD/friends target=“_parent”>Friends</a>

Once the second response is sent to the client, a third HTTP request is triggered from the client to the first domain name, at step 145. In an embodiment of the present invention, the second response includes an HTML element that triggers the third HTTP request from the client to the first domain name. The HTML element can include, but is not limited to, an image tag, a frame tag, an iframe tag, a script tag, a link tag or an on-load form post. The HTML element triggering the third HTTP request ensures that the URL in the user's browser remains unchanged, that is, the URL still points to the first domain name.

In another embodiment of the present invention, the third HTTP request can be triggered from any HTTP response coming from the central domain name.

The third HTTP request sends a third session identifier to the first domain name. Those skilled in the art will appreciate that, to send the third session identifier to the first domain name, the following HTML command can be used:

<frameset rows=“100%,0%”>

<frame id=“zeroFrame”

src=“http://jack.TLD/sessionmigrator?jsessionid=<<Third Session
Identifier>>”
noresize>
</frameset>

Upon receiving the third session identifier for the first domain name, it is verified if the third session identifier represents the same application session as the second session identifier, at step 150. If the third session identifier is identified to represent the same application session, the third session identifier is set on the first domain name for the client at step 155. The third session identifier can be set as a cookie on the client for the first domain name. Those skilled in the art will appreciate that to set the third session identifier for the first domain name, the following HTML Header can be used:

Set-Cookie:jsessionid=<<Third Session Identifier>>;domain=Jack.TLD

The application session is now aggregated and active for the client on the plurality of domain names and subsequent requests would directly serve content.

For instance, when the user now sends an HTTP request to Jill.TLD, which hosts the same application as Jack.TLD, it is checked if the HTTP request includes a session identifier for Jill.TLD. If the user currently does not have an active session on Jill.TLD, a response is sent to the user that triggers an HTTP request to the central domain name. Since, in accordance with the example above, the user already has an active session on the central domain name, a response is sent to the user that triggers an HTTP request being sent to Jill.TLD, wherein a session identifier is set for the user on Jill.TLD and the resource hosted on Jill.TLD is rendered directly to the user. It will be appreciates that in the above process, the URL in the user's browser does not change to the central domain name and is retained as Jill.com, thus, enhancing the user experience.

Those skilled in the art will realize that the third session identifier can be the same as the first session identifier. In an embodiment of the present invention, all three session identifiers, namely the first session identifier, the second session identifier and the third session identifier, are the same string. In another embodiment, the first session identifier, the second session identifier and the third session identifier are different strings. The first session identifier, the second session identifier and the third session identifier however represent the same application session across all the plurality of domain names.

In an embodiment of the present invention, when the client logs out of the application session on any of the plurality of domain names, the application session is terminated for the client on all of the plurality of domain names. In that, the first session identifier, the second session identifier and the third session identifier are invalidated on the plurality of domain names by deleting them from an application server serving the application on the plurality of domain names. This ensures quick and easy log out process for the user.

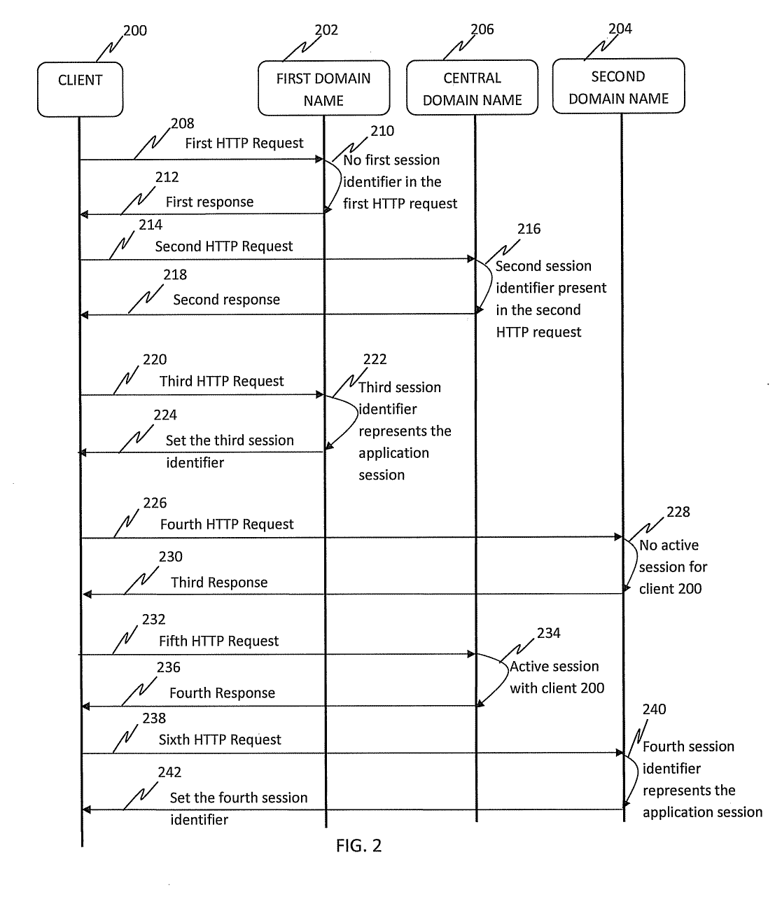

Referring now to FIG. 2, a call flow diagram representing sharing of an application session across a plurality of domain names is shown in accordance with an embodiment of the present invention. A client 200 may wish to access a first domain name 202 that renders an application on the internet. The same application maybe rendered by a plurality of domain names. For instance, a social networking service may host a first user's profile on first domain name 202 and a second user's profile on a second domain name 204. In this scenario the application rendered on the two domain names is the same, namely user profiles, however the content on the two domain names may be different, based on each user's profile.

Further, in accordance with an embodiment of the present invention, a central domain name 206 hosts the same application as first domain name 202 and second domain name 204. In another embodiment, central domain name 206 hosts a different application than that hosted by first domain name 202 and second domain name 204.

At 208, client 200 sends a first HTTP request to first domain name 202. At 210, it is checked if the first HTTP request includes a first session identifier set for client 200 on first domain name 202. The first session identifier can be a cookie set on the user's browser. Thus, if a live session exists for client 200 on first domain name 202, the first session identifier, or a cookie, is found to be present on client 200.

If the first HTTP request includes a first session identifier, it implies that client 200 has an active session on first domain name 202 and a resource hosted on first domain name 202 is rendered to client 200.

If the first session identifier is absent in the first HTTP request, it implies that client 200 has no live session on first domain name 202. This can happen when, for example, client 200 is not logged into the application being rendered on first domain name 202.

When the first session identifier is absent in the first HTTP request, a first response is sent to client 200 at 212. The first response comprises at least a first HTML page. The first HTML page may include a frame tag that triggers a second HTTP request to central domain name 206 at step 214. The frame tag can be of the form:

<frameset rows=“100%,0%”>

<frame id=“internalUrlFrame” src=“central domain name”
noresize>

</frameset>

Those skilled in the art will realize that the src=“central domain name” will cause the second HTTP request to be sent to central domain name 206. Further, a <frameset> tag ensures that the second HTTP request is sent to central domain name 206 transparently without changing the domain name in a browser address bar of client 200 to central domain name 206. Thus, for client 200, the second HTTP request to central domain name 206 is invisible.

At 216, it is determined if the second HTTP request includes a second session identifier for central domain name 206 representing the application session. If client 200 is visiting central domain name 206 for the first time, or does not have an active application session on central domain name 206, there may be no second session identifier in the second HTTP request.

If the second session identifier is absent in the second HTTP request, the application session is created for client 200 and the second session identifier is set on central domain name 206 for client 200. In an embodiment of the invention, for creating the application session, a login page is rendered to client 200. The user can then either enter his credentials, such as username and password, or create a new account if he is a new user. Once the credentials are validated, client 200 is logged into the application and the application session is created for client 200.

The login page can be rendered in a frame within the browser window of client 200. This ensures that the URL in the browser address bar of client 200 does not change to central domain name 206 and is retained as first domain name 202.

In an embodiment of the present invention, the second session identifier is set for client 200 on a plurality of sub-domains under central domain name 206. For instance, if central domain name 206 is home.TLD, the second session identifier can be set on home.TLD, jack.home.TLD, Jill.home.TLD etc.

Once the second session identifier is set on client 200 for central domain name 206 or it is determined, at 216, that the second HTTP request includes the second session identifier, a second response is sent to client 200 at 218. The second response includes a second HTML page. The second HTML page can be the resource hosted on first domain name 202 as requested by client 200 in the first HTTP request at 208. For instance, the resource can be the user's profile hosted on first domain name 202.

For example, if first domain name 202 is Jack.TLD and central domain name 206 is home.TLD, then jack.home.TLD is sent as the second response to client 200 at 218. This can be done using the following HTML command:

<frameset rows=“100%,0%”>

<frame id=“mainFrame” src=“http://jack.home.TLD”>

</frameset>

Those skilled in the art will appreciate that jack.home.TLD can point to the same resource as Jack.TLD. Further, one or more links rendered in the “mainFrame” can all point to first domain name 202, jack.TLD, and not to sub-domains within central domain name 206, such as photos.jack.home.TLD, since jack.home.TLD points to the same resource as jack.TLD. This can be done by setting the ‘target’ attribute of the one or more links within the “mainFrame” to “_parent”. This ensures that the URL in the user's browser is consistent with the resource being rendered. The target can be set using the following HTML command:

<a href=“http://jack.TLD/friends target=“_parent”>Friends</a>

Once the second response is sent to client 200 at 218, a third HTTP request is triggered from client 200 to first domain name 202, at 220. In an embodiment of the present invention, the second response includes an HTML element that triggers the third HTTP request from client 200 to first domain name 202. The HTML element can include, but is not limited to, an image tag, a frame tag, an iframe tag, a script tag, a link tag or an on-load form post. The HTML element triggering the third HTTP request ensures that the URL in the browser address bar of client 200 remains unchanged, that is, the URL still points to first domain name 202.

In another embodiment of the present invention, the third HTTP request can be triggered from any HTTP response coming from central domain name 206.

The third HTTP request sends a third session identifier to first domain name 202. Those skilled in the art will appreciate that, to send the third session identifier to first domain name 202, the following HTML command can be used:

<frameset rows=“100%,0%”>

<frame id=“zeroFrame”

src=“http://jack.TLD/sessionmigrator?jsessionid=<<Third Session
Identifier>>”
noresize>
</frameset>

Upon receiving the third session identifier for first domain name 202, it is verified if the third session identifier represents the same application session as the second session identifier, at 222. If the third session identifier is identified to represent the same application session, the third session identifier is set on first domain name 202 for client 200 at 224. Those skilled in the art will appreciate that to set the third session identifier for the first domain name, the following HTML Header can be used:

Set-Cookie:jsessionid=<<Third Session Identifier>>;domain=Jack.TLD

The application session is now aggregated and active for client 200 on the plurality of domain names and subsequent requests would directly serve content.

For instance, when client 200 now sends a fourth HTTP request to second domain name 204, which hosts the same application as first domain name 202, at 226, it is checked if the fourth HTTP request includes a session identifier for second domain name 204 at 228. If client 200 currently does not have an active session on second domain name 204, a third response is sent to client 200 at 230. The third response triggers a fifth HTTP request to central domain name 206 at 232. It is determined that client 200 already has an active session on central domain name 206 at 234. A fourth response is sent to client 200 at 236, that triggers a sixth HTTP request being sent to second domain name 204 at 238. The sixth HTTP request sends a fourth session identifier to second domain name 204. It is verified at 240 if the fourth session identifier represents the same application session as the second session identifier. Once this is verified, the fourth session identifier is set for client 200 on second domain name 204 at 242, and the resource hosted on second domain name 204 is rendered directly to client 200.

It will be appreciates that in the above process, the URL in the browser address bar of client 200 does not change to central domain name 206 and is retained as second domain name 204, thus, enhancing user experience.

As mentioned above in conjunction with FIG. 1, the third session identifier can be the same as the first session identifier. In an embodiment of the present invention, all session identifiers, namely the first session identifier, the second session identifier, the third session identifier and the fourth session identifier are the same string. In another embodiment, the first session identifier, the second session identifier, the third session identifier and the fourth session identifier are different strings. The first session identifier, the second session identifier, the third session identifier and the fourth session identifier however represent the same application session across all the plurality of domain names.

In an embodiment of the present invention, when client 200 logs out of the application session on any of the plurality of domain names, the application session is terminated for client 200 on all of the plurality of domain names. In that, the first session identifier, the second session identifier, the third session identifier and the fourth session identifier are invalidated on the plurality of domain names by deleting them from an application server serving the application on the plurality of domain names. This ensures quick and easy log out process for client 200.

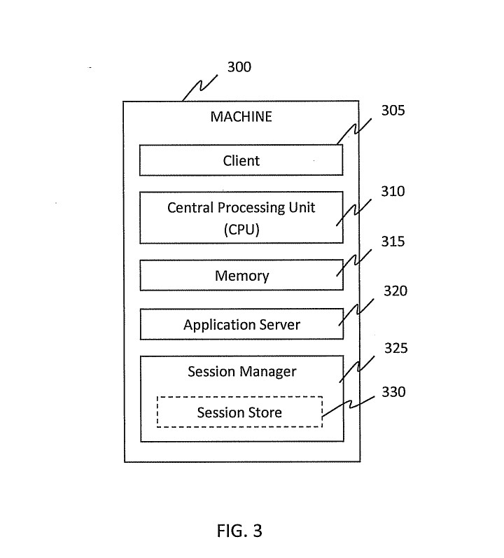

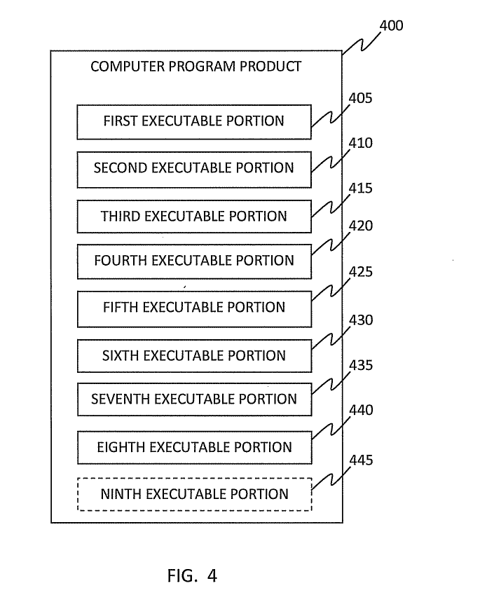

Turning now to FIG. 3, a block diagram of a machine 300 for sharing of an application session across a plurality of domain names is shown in accordance with an embodiment of the present invention. Machine 300 comprises one or more connected components that enable a user to seamlessly browse from one domain name to another domain name that host a same application, without having to login again and without the URL in the user's browser changing.

Machine 300 comprises a client 305, a central processing unit (CPU) 310 and a memory 315. Those skilled in the art will realize that client 200 in FIG. 2 is depicted as client 305 in FIG. 3. Client 305 can be one or more of, but not limited to, a user, a browser, a user's desktop etc.

Client 305 may wish to visit a first domain name from the plurality of domain names that host an application, such as a user's profile on a social network. An application server 320 serves this application to the plurality of domain names.

To access the application on the first domain name, client 305 sends a first HTTP request to the first domain name. A session manager 325 in conjunction with application server 320 is configured to receive the first HTTP request for client 305. Session manger 325 then determines if the first HTTP request comprises a first session identifier for the first domain name.

As mentioned earlier, if the first HTTP request includes the first session identifier for the first domain name, it implies that client 305 has an active session on the first domain name. If session manager 325 determines that the first session identifier is absent in the first HTTP request, session manager 325 sends a first response to client 305. The first response comprises a first HTML page that includes a frame tag for triggering a second HTTP request directed to a central domain name. The frame tag can be of the form:

<frameset rows=“100%,0%”>

<frame id=“internalUrlFrame” src=“central domain name”
noresize>

</frameset>

src=“central domain name” causes the second HTTP request to be sent to the central domain name from the client 305. Further, a <frameset> tag ensures that the second HTTP request is sent to the central domain name transparently without changing the domain name in a browser address bar of client 305 to the central domain name. Thus, for client 305, the second HTTP request to the central domain name is invisible.

Session manager 325 receives the second HTTP request for the central domain name from client 305. Session manager 325, in conjunction with application server 320, then determines if the second HTTP request comprises a second session identifier for the central domain name.

If the second HTTP request does not include the second session identifier, it implies that client 305 does not have any active session on the central domain name. In this case, session manager 325, in conjunction with application server 320, is configured to create the application session on the central domain name for client 305 and to set a new session identifier representing the application session for client 305 on the central domain name. The new session identifier is the second session identifier.

To create the application session, session manager 325 in conjunction with application server 320 is configured to render a login page to client 305 and receive one or more credentials entered by client 305. Session manager 325 validates the credentials and logs client 305 into the application accordingly.

Session manager 325, in conjunction with application server 320, can render the login page in a frame within the browser window of client 305. This ensures that the URL in the browser address bar of client 305 does not change to the central domain name and is retained as the first domain name.

In an embodiment of the present invention, session manager 325, in conjunction with application server 320, sets the second session identifier for client 305 on a plurality of sub-domains under the central domain name. For instance, if the central domain name is home.TLD, session manager 325 can set the second session identifier on home.TLD, jack.home.TLD, Jill.home.TLD etc.

Once session manager 325 sets the second session identifier on client 305 for the central domain name or it determines that the second HTTP request includes the second session identifier, session manager 325 sends a second response to client 305. The second response comprises a second HTML page that can be a resource hosted on the first domain name as requested by client 305 in the first HTTP request.

The nature of the second response is described in detail in conjunction with FIG. 1 and FIG. 2 above.

Once session manager 325 sends the second response to client 305, a third HTTP request is triggered from client 305 to the first domain name. In an embodiment of the present invention, the second HTML page includes an HTML element that triggers the third HTTP request for the first domain name from client 305.

In another embodiment of the present invention, the third HTTP request can be triggered from any HTTP response coming from the central domain name.

Session manager 325 receives the third HTTP request for the first domain name. In accordance with the present invention, the third HTTP request sends a third session identifier to the first domain name. Session manager 325, in conjunction with application server 320, verifies that the third session identifier indeed represents the same application session as the second session identifier. If the third session identifier is identified to represent the same application session, session manager 325, in conjunction with application server 320, sets the third session identifier on the first domain name for client 305.

In an embodiment of the present invention, session manager 325 is configured to set the third session identifier as a cookie on a browser of client 305.

The application session is now aggregated and active for client 305 on the plurality of domain names and subsequent requests would directly serve content.

It will be appreciates by those skilled in the art that throughout the above process, machine 300 ensures that the URL in the browser address bar of client 305 does not change to the central domain name and is retained as the first domain name, thus, enhancing user experience.

In an embodiment of the present invention, session manager 325 comprises a session store 330. Session store 330 can include one or more session records pertaining to client 305 on the plurality of domain names. One or more session records may include the first session identifier, the second session identifier and the third session identifier. In general, the one or more session records can include all session identifiers involved in a single application session for a particular client.

When client 305 logs out of the application session, session manager 325 invalidates the one or more session records on the plurality of domain names. For invalidating the session records, all the session identifiers involved in the application session, such as the first session identifier, the second session identifier and the third session identifier, are deleted from application server 320 and/or client 305. This ensures quick and easy log out process for client 305.

Turning now to FIG. 4, a block diagram depicting a computer program product 400 for facilitating sharing of an application session across a plurality of domain names without changing a URL in a browser a client is shown in accordance with an embodiment of the present invention.

Computer program product 400 comprises at least one computer-readable medium having one or more computer-readable program code portions stored therein. The one or more computer-readable program code comprise of a first executable portion 405 for receiving a first HTTP request for a first domain name from the client.

A second executable portion 410, then, determines if the first HTTP request for the first domain name comprises a first session identifier. The determining step is described in detail in conjunction with FIG. 1 above.

If the first session identifier is present in the first HTTP request, a third executable portion 415 renders a resource being hosted on the first domain name to the client. When the first session identifier is absent in the first HTTP request, third executable portion 415 sends a first response to the client.

The first response comprises a first HTML page that may include a frame tag for triggering a second HTTP request directed to a central domain name.

A fourth executable portion 420, then, determines if the second HTTP request for the central domain name includes a second session identifier. If the second session identifier is absent in the second HTTP request, fourth executable portion 420 creates the application session on the central domain name for the client and sets a new session identifier representing the application session for the client on the central domain name. The new session identifier is the second session identifier.

To create the application session, fourth executable portion 420 renders a login page to the client and receives one or more credentials entered by client 305. Fourth executable portion 420 validates the credentials and logs client 305 into the application accordingly.

Fourth executable portion 420 can render the login page in a frame within the browser window of the client. This ensures that the URL in the browser address bar of the client does not change to the central domain name and is retained as the first domain name.

In an embodiment of the present invention, fourth executable portion 420 sets the second session identifier for the client on a plurality of sub-domains under the central domain name. For instance, if the central domain name is home.TLD, fourth executable portion 420 can set the second session identifier on home.TLD, jack.home.TLD, Jill.home.TLD etc.

Once fourth executable portion 420 sets the second session identifier on the central domain name or when the second HTTP request already contains the second session identifier, a fifth executable portion 425 sends a second response to the client. The second response comprises a second HTML page, which can be the resource hosted on the first domain name as requested by the client in the first HTTP request. The second HTML page can include an HTML element for triggering a third HTML request from the client to the first domain name. As mentioned earlier, the third HTML request can be triggered from any HTTP response coming from the central domain name.

A sixth executable portion 430 receives the third HTTP request from the client to the first domain name. The third HTTP request sends a third session identifier to the first domain name. A seventh executable portion 435 verifies that the third session identifier represents the same application session as the second session identifier.

Upon the verification, an eighth executable portion 440 finally sets the third session identifier on the first domain name for the client.

The application session is now aggregated and active for the client on the plurality of domain names and subsequent requests would directly serve content.

An embodiment of the present invention further includes a ninth executable portion 445 that maintains a store of one or more session records pertaining to the application session. When the client logs out of the application on any of the plurality of domain names, ninth executable portion 445 invalidated all of the one or more session records. That is, the first session identifier, the second session identifier, the third session identifier and any other session identifiers pertaining to the application session are deleted.

Various embodiment of the present invention enable sharing of an application session across a plurality of domain names, without having the client to login again and without the URL in a browser address bar of the client changing to the central domain name. This gives a user a complete seamless experience when he navigates from one domain name to another, that host the same application, since there is no redirection involved.

What is claimed is:

1. A method for sharing an application session across a plurality of domain names without changing a URL in a browser of a client, the plurality of domain names hosting an application, the method comprising:
receiving a first HTTP request for a first domain name from the client, the first domain name belonging to the plurality of domain names;
determining if the first HTTP request for the first domain name comprises a first session identifier;
sending a first response to the client when the first session identifier is absent in the first HTTP request, wherein the first response comprises a first HTML page, the first HTML page comprising a frame tag, the frame tag triggering a second HTTP request directed to a central domain name; the central domain name belonging to the plurality of domain names;
determining if the second HTTP request for the central domain name comprises a second session identifier representing the application session;
sending a second response to the client when the second session identifier is present in the second HTTP request, the second response comprising a second HTML page, the second HTML page being a resource hosted on the first domain name as requested by the client in the first HTTP request;
triggering a third HTTP request from the client to the first domain name, the third HTTP request sending a third session identifier to the first domain name;
verifying at the first domain name that the third session identifier represents the application session; and
setting the third session identifier on the first domain name for the client, when the third session identifier represents the application session.

2. The method of claim 1 wherein the setting step comprises storing the third session identifier as a cookie on a browser of the client.

3. The method of claim 1 wherein the first session identifier, the second session identifier and the third session identifier are one of a same string and two or more different strings, wherein the first session identifier, the second session identifier and the third session identifier represent the application session.

4. The method of claim 1, wherein when the second session identifier is absent in the second HTTP request, the method comprises:
creating the application session on the central domain name for the client; and
setting a new session identifier representing the application session as the second session identifier for the client on the central domain name.

5. The method of claim 4, wherein the creating step comprises:
rendering a login page to the client;
receiving one or more credentials from the client;
validating the one or more credentials; and
logging in the client.

6. The method of claim 4, wherein the second session identifier is set for the client on a plurality of sub-domains under the central domain name, the plurality of sub-domains under the central domain name belonging to the plurality of domain names.

7. The method of claim 1, wherein the first domain name belongs to a first Top Level Domain (TLD) and the central domain name belongs to a second TLD, wherein the first TLD and the second TLD are one of a same TLD and two different TLDs.

8. The method of claim 1, wherein the second HTML page comprises an HTML element, the HTML element triggering the third HTTP request to the first domain name.

9. The method of claim 8, wherein the HTML element comprises one or more of an image tag, a frame tag, an iframe tag, a script tag, a link tag and an on-load form post.

10. The method of claim 1, wherein when the client logs out of the application session, the method further comprises invalidating the first session identifier, the second session identifier and the third session identifier on the plurality of domain names, the invalidating step comprising deleting the first session identifier, the second session identifier and the third session identifier from one or more of an application server and the client, the application server serving the application on the plurality of domain names.

11. The method of claim 1, wherein the client is one or more of a user and a browser.

12. The method of claim 1, wherein the application is one or more of a social networking application, a photo management application, a video publishing application, an email application and a messaging application.

13. A machine for sharing an application session across a plurality of domain names without changing a URL in a browser of a client, the plurality of domain names hosting an application, the machine comprising one or more connected components, the one or more connected components comprising:
a central processing unit;
a memory;
a client, the client sending a first HTTP request for a first domain name, the first domain name belonging to the plurality of domain names;
an application server, the application server serving the application to the plurality of domain names,
a session manager, the session manager in conjunction with the application server configured to:
receive the first HTTP request for a first domain name from the client;
determine if the first HTTP request comprises a first session identifier for the first domain name;
send a first response to the client when the first session identifier is absent in the first HTTP request, wherein the first response comprises a first HTML page, the first HTML page comprising a frame tag, the frame tag triggering a second HTTP request directed to a central domain name, the central domain name belonging to the plurality of domain names;
receive the second HTTP request for the central domain name from the client;
determine if the second HTTP request comprises a second session identifier;
send a second response to the client when the second session identifier is present in the second HTTP request, the second response comprising a second HTML page, the second HTML page being a resource hosted on the first domain name as requested by the client in the first HTTP request;
receive a third HTTP request for the first domain name, the third HTTP request sending a third session identifier to the first domain name;
verify that the third session identifier represents the application session; and
setting the third session identifier on the first domain name for the client, when the third session identifier represents the application session.

14. The machine of claim 13, wherein the session manager is configured to set the third session identifier as a cookie on a browser of the client.

15. The machine of claim 13, wherein when the second session identifier is absent in the second HTTP request, the session manager is configured to:
create the application session on the central domain name for the client; and
set a new session identifier representing the application session as the second session identifier for the client on the central domain name.

16. The machine of claim 1, wherein for creating the application session, the session manager is configured to:
render a login page to the client;
receive one or more credentials from the client;
validate the one or more credentials; and
log in the client.

17. The machine of claim 15, wherein the session manager sets the second session identifier for the client on a plurality of sub-domains under the central domain name, the plurality of sub-domains under the central domain name belonging to the plurality of domain names.

18. The machine of claim 13, wherein the second HTML page comprises an HTML element, the HTML element triggering the third HTTP request for the first domain name

19. The machine of claim 13, wherein the session manager further comprises a session store the session store comprising one or more session records pertaining to the client on the plurality of domain names.

20. The machine of claim 19, wherein when the client logs out of the application session, the session manager invalidates the one or more session records on the plurality of domain names, wherein the invalidating step comprises deleting the first session identifier, the second session identifier and the third session identifier from one or more of the application server and the client.

21. A computer program product to facilitate sharing of an application session across a plurality of domain names without changing a URL in a browser of a client, the plurality of domain names hosting an application, wherein the computer program product comprises at least one computer-readable medium having one or more computer-readable program code portions stored therein, the one or more computer-readable program code portions comprising:
a first executable portion for receiving a first HTTP request for a first domain name from the client, the first domain name belonging to the plurality of domain names;
a second executable portion determining if the first HTTP request for the first domain name comprises a first session identifier;
a third executable portion for sending a first response to the client when the first session identifier is absent in the first HTTP request, wherein the first response comprises a first HTML page, the first HTML page comprising a frame tag, the frame tag triggering a second HTTP request directed to a central domain name, the central domain name belonging to the plurality of domain names;
a fourth executable portion for determining if the second HTTP request for the central domain name comprises a second session identifier;
a fifth executable portion for sending a second response to the client when the second session identifier is present in the second HTTP request, the second response comprising a second HTML page, the second HTML page a being the resource hosted on the first domain name as requested by the client in the first HTTP request;
a sixth executable portion for receiving a third HTTP request from the client to the first domain name, the third HTTP request sending a third session identifier to the first domain name;
a seventh executable portion for verifying that the third session identifier represents the application session; and
a eighth executable portion for setting the third session identifier on the first domain name for the client, when the third session identifier represents the application session.
